(19) United States
(12) Patent Application Publication
(10) Pub. No.: US 2009/0316841 A1
(43) Pub. Date: Dec. 24, 2009

(54) NULL DETECTION AND ERASURE DECODING FOR FREQUENCY SELECTIVE CHANNELS IN A BROADCASTING SYSTEM

(75) Inventors: Yan Li, Newtown, PA (US); Feng Huang, Hoffman Estates, IL (US); Ravikiran Rajagopal, Yardley, PA (US); Troy Schaffer, Newtown, PA (US)

Correspondence Address: MCANDREWS HELD & MALLOY, LTD, 500 WEST MADISON STREET, SUITE 3400, CHICAGO, IL, 60661, US

(73) Assignee: ADVANCED MICRO DEVICES, INC., Sunnyvale, CA (US)

(21) Appl. No.: 12/143,434

(22) Filed: Jun. 20, 2008

(51) Int. Cl. H04L 27/28

(52) U.S. Cl. 375/346

(57) ABSTRACT

A null detection and erasure decoding process for a frequency selective channel in a broadcasting system. An orthogonal frequency-division multiplexing (OFDM) receiver receives an input bitstream, determines a noise level of the received input bitstream, and then detects a null in the input bitstream based on the noise level. Once a null is detected, the presence of the null is signaled to a decoder, allowing the decoder to process the null as an erasure.

### BACKGROUND

For broadcasting systems, such as a Digital Video Broadcasting-Terrestrial (DVB-T) system, the use of single frequency networks (SFNs) allows the constructive superposition of identical signals from more than one transmitter based on orthogonal frequency division multiplexing (OFDM). An SFN consists of several transmitters operating at the same frequency. Due to the properties of the OFDM modulation used in the DVB-T system, coupled with careful synchronization of the transmitters, non-destructive interference can be introduced between signals received from several different transmitters. The transmitter synchronization (in terms of both time and frequency) is achieved by injecting specific timing information at the head-end of the network, and by providing an automatic alignment system in each transmitter. A common time and frequency reference, (e.g. a GPS reference), is used at each receiver site. The benefits derived from this system are improved coverage and better utilization of the available spectrum.

In an SFN, signals reflecting off of physical structures (e.g. by mountains or buildings) may create an echo channel of the transmitted signal. Under laboratory conditions, a 0 dB long echo channel is used extensively to characterize the performance of a TV demodulator. One special property of a 0 dB long echo channel is that it causes deep fading or a null in the frequency domain. For an OFDM system, such as a DVB-T system, a deep fading or a null appears as an erasure to a demapper/convolution decoder, where an erasure is an error in which the location is known, but the value of the error is not. An erasure in the convolution decoder may cause performance degradation to the OFDM receiver during playback, as explained below.

FIG. 1 shows a frequency response for a 0 dB channel in which 20 nulls are shown. During the null periods shown, the data carried on the signal is replaced with noise. The x-axis represents the signal amplitude and the y-axis represents the OFDM carrier index in frequency, and the graph is plotted in linear scale.

Typically, in an OFDM receiver, a soft demapper receives an equalized signal that is a complex multi-level value and converts the complex value to soft binary-scale values, which can be a zero or a one, but more likely a value in between. The convolution decoder then decodes the soft values and creates an image for playback. However, if the frequency channel response has deep fading or nulls on a certain carrier, the carried information, which is sent to the soft demapper, is completely eliminated and there is no reliable way to recover the lost information. In this scenario, the convolution decoder receives noise from the soft demapper and attempts to create an image based on the received noise. Any decision made by the decoder during the null will be based on the noise and will have a high error rate. This high error rate will degrade the convolution decoder performance.

Generally, it is easier for a convolution decoder to recover data from a missed signal than it is for a convolution decoder to recover data from decoding a signal comprising only noise. Therefore, it would be beneficial to prevent the convolution decoder from decoding a signal comprising only noise. While erasure decoding is a common method used in network coding to combat erasure packet loss in the transportation layer, no method exists to combat nulls in an SFN. Therefore, a method and apparatus for erasure decoding to reduce the effects of deep fading or nulls caused by the long echo channel in an SFN is desired.

### SUMMARY

A null detection and erasure decoding process for a frequency selective channel in a broadcasting system is disclosed. The method may comprise receiving an input bitstream, determining a noise level of the received input bitstream, and detecting a null in the input bitstream based on the noise level. Once a null is detected, the presence of the null can be signaled to the decoder, allowing the decoder to process the null as an erasure.

### BRIEF DESCRIPTION OF THE DRAWINGS

A more detailed understanding may be had from the following description, given by way of example and to be understood in conjunction with the accompanying drawings wherein:

FIG. 1 shows a frequency response of a 0 dB echo channel with 20 nulls;

FIG. 2 is an example OFDM system; and

FIG. 3 is a flow diagram of a process for null detection in an SFN.

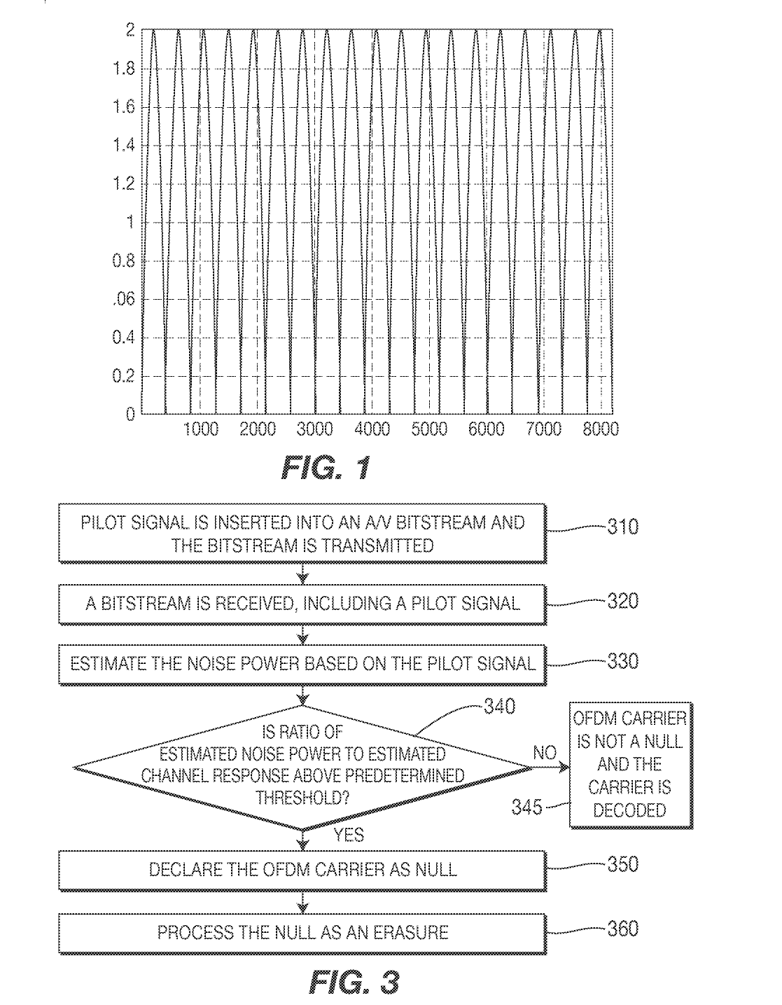

### DETAILED DESCRIPTION

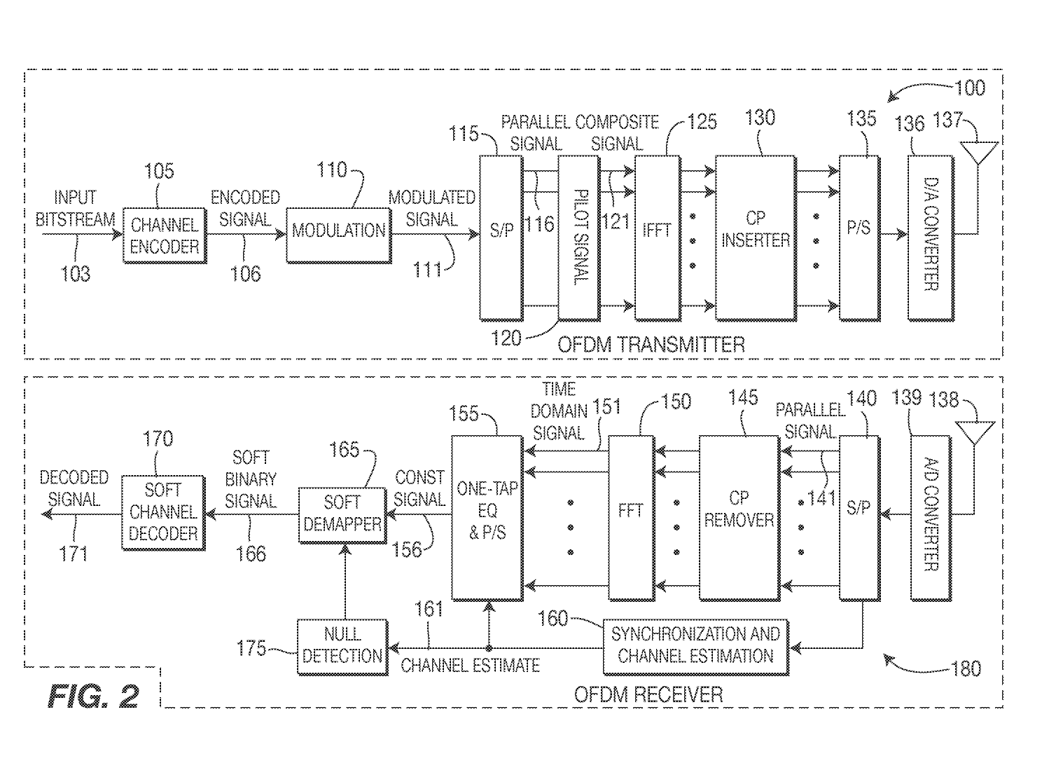

A baseband equivalent OFDM system is shown in FIG. 2, including an OFDM transmitter 100 and an OFDM receiver 180. It would be understood by those of skill in the art that the OFDM transmitter 100 includes a channel encoder 105, a modulation block 110, a serial-to-parallel (S/P) converter 115, a pilot signal block 120, an inverse fast Fourier transform (IFFT) block 125, a cyclic prefix (CP) inserter 130, a parallel-to-serial (P/S) converter 135, a digital-to-analog converter 136, and a transmitter antenna 137. The OFDM receiver 180 includes a receiver antenna 138, an analog-to-digital converter 139, an S/P converter 140, a CP remover 145, a fast Fourier transform (FFT) block 150, a one-tap equalizer (EQ) and P/S shifter 155, a synchronization and channel estimation (SCE) block 160, a soft demapper 165, a soft channel decoder 170 and a null detection block 175.

Referring to the OFDM transmitter 100 of FIG. 2, an input bitstream 103 is received by a channel encoder 105. The channel encoder 105 performs channel coding on the input bitstream 103 and outputs an encoded signal 106. The modulation block 110 receives the encoded signal 106 and performs modulation (e.g., quadrature phase shift keying (QPSK), 8-ary PSK (8 PSK), 16-ary quadrature amplitude modulation (16 QAM, 64 QAM, 256 QAM, etc.) and outputs a modulated signal 111. The S/P converter 115 receives the modulated signal 111 and converts it into a parallel signal 116. The pilot signal block 120 receives the parallel signal 116, inserts a pilot signal, and outputs a composite signal 121.

The composite signal 121 is received by the IFFT block 125, which performs IFFT processing and converts the composite signal 121 into a time domain signal. More specifically, the IFFT block 125 is used to transform the mapped data sequence length N{X(k)} from frequency domain into time domain signal {x(n)}. Where x(n) can be calculated by the following equation:

$$x ( n ) = \sqrt{N} {\sum }_{n = 0}^{N - 1} X ( k ) {e}^{j \frac{2 π}{N} nk} \qquad Equation ( 1 )$$

In the IFFT processing, a guard interval with length N_{g}, which is chosen to be larger than the expected channel delay spread, is inserted into the beginning of the symbol to avoid inter-symbol interference (ISI). The time domain signal {x(n)} is transmitted through a linear time variant channel. The time variant channel is modeled by a time-variant discrete impulse response h(n,l), defined as the time-n response to an impulse applied at time n−l. Assuming the maximum channel delay Nₖ, where Nₕ≦N_{g}, a signal received at the receiver could be represented as:

$${y}_{d} ( n ) = {\sum }_{t = 0}^{{N}_{h} - 1} h ( n , l ) {x}_{d} ( n - l ) + w ( n ) , 0 \leq n \leq N \qquad Equation ( 2 )$$

where the w(n) is the white Gaussian noise with variance σ². After removing the guard interval at the beginning, the received signal sequence {y(n)} will be passed to a N-point FFT to reverse the IFFT operation described by Equation (1).

$$Y ( k ) + \frac{1}{\sqrt{N}} {\sum }_{n = 0}^{N - 1} y ( n ) {e}^{- j \frac{2 π}{N} nk} \qquad Equation ( 3 )$$

Equation (3) can be rewritten as follows:

Y=HX+N Equation (4)

where H and N are frequency channel matrix and frequency transform of noise, respectively. For simplicity, a static channel is assumed as an example. The frequency channel matrix of a static channel is a diagonal matrix.

The CP inserter 130 receives the output of the IFFT block 125 and inserts a CP into the output of the IFFT block 125. The output of CP inserter 130 is converted into a serial digital signal by P/S converter 135. The serial digital signal is then passed through the digital-to-analog converter 136 which converts it to an analog signal that is transmitted through the transmitting antenna 137.

Referring to the OFDM receiver 180 of FIG. 2, the receiver antenna 138 receives the analog signal. The analog-to-digital converter 139 converts it to a digital format. The S/P converter 140 converts the digital signal into a parallel signal 141. The CP remover 145 receives the parallel signal 141 and removes the CP. The output of the S/P converter 140 is also received by the SCE block 160. The SCE block 160 creates a channel estimate 161 by estimating the noise power based on the inserted pilot signal or other similar signal, (e.g. Transmission Parameter Signaling (TPS) in DVB-T and transmission and multiplexing configuration control (TMCC) in Integrated Services Digital Broadcasting-Terrestrial (ISDB-T)).

The FFT block 150 receives the output signal of the CP remover 145 and performs FFT processing on it. The time domain signal 151 is output from the FFT block 150.

When the channel estimate 161 is available from the SCE block 160, the output of the FFT block 150 is signaled to the one-tap EQ and P/S shifter 155. Although a one-tap EQ is shown, alternatively an equalizer with ICI cancellation may be used. The one-tap EQ and P/S shifter 155 compensates any channel effects and improves the bit error rate (BER) performance and converts the received time domain signal 151 signal into a serial signal. This serial signal is output as an equalized constellation signal 156.

The null detection block 175 receives the output of the SCE block 160 in parallel with the one-tap EQ and P/S shifter 155. The null detection block 175 uses a null detection process to detect nulls that are incorporated in the analog signal. The null detection block 175 then signals to the soft demapper 165 that nulls are present in the OFDM carrier of the analog signal.

Denoting an estimated noise power as N_{CP} and an estimated channel response as \tilde{H}ₖ, where k is the OFDM sub-carrier index, the null detection process of null detection block 175 can be described as follows:

$$\begin{matrix}kth sub \text{-} carrier is \\ a null , if\end{matrix} \{ \begin{matrix}{\vert {\tilde{H}}_{k} \vert}^{2} < α \cdot {N}_{cp} & when {N}_{cp} > P \\ \vert {\tilde{H}}_{k} \vert < α \cdot {N}_{cp} & when {N}_{cp} \leq P\end{matrix} \qquad Equation ( 5 )$$

where α is a programmable constant factor and P is programmable constant threshold. The programmable constant α is chosen to make the number of false alarms as small as possible (with 0 being the best). They are implemented as a register in the demodulator.

In another embodiment, the null detection process of null detection block 175 may be described as follows:

$${\vert {\tilde{H}}_{k} \vert}^{2} < α \cdot {\vert \overline{H} \vert}^{2} \qquad Equation ( 6 )$$

where | H̅| is the amplitude of average estimated channel response.

The soft demapper 165 receives and demodulates the equalized constellation signal 156 and converts it to a soft binary signal 166, which is input to the soft channel decoder 170. The soft binary signal 166 has a range of [0, . . . , 1] and is a measure of how likely a bit in the received equalized constellation signal 156 is a zero or a one. Thus, the soft binary signal 166 conveys more information about each bit than just a zero or a one.

As noted above, the output of the null detection block 175 signals the soft demapper 165 of any nulls, and the soft demapper 165 signals the soft channel decoder 170 of the null so it can process the null as an erasure. The signal input to soft demapper may have multiple levels. The soft demapper maps a multi-level signal to one or several soft binary values, depending on the number of levels. If a null occurs, the one multi-level signal is erasured. The soft valued corresponding to the one multi-level is then set to a value of 0.5 (or 0 if the range is [−1 . . . 1]) to signal the erasure information to the soft channel decoder 170. For example, the soft demapper 165 can set a soft binary signal 166 to a value of 0.5 when it is informed by null detection block 175 that the equalized constellation signal 156 is distorted by a deep fading or a null. By transmitting a value of 0.5, the soft demapper 165 signals the soft channel decoder 170 that no meaningful decision can be made based on the received soft binary signal 166. Accordingly, the soft demapper 165 may include an erasure forcer that converts demodulates the equalized constellation signal 156 to a value of 0.5 and outputs the soft binary signal 166.

After processing the soft binary signal 166, the soft channel decoder 170 outputs a decoded signal 171. If the erasure forcer is set to identify a value of 0.5 to indicate a presence of an erasure, then when a soft binary signal 166 with the value of 0.5 is received, the soft channel decoder 170 would know to process the data as an erasure. Alternatively, a separated signal may be transmitted to the decoder to alert the decoder of an erasure. The decoder may then be modified to stop making a decision when the erasure is marked.

FIG. 3 is a flow diagram of a null detection process in an SFN. Prior to transmission, one or more pilot signals are inserted into an A/V signal (310). A receiver receives the A/V signal including the pilot signal (320). The noise power is estimated based on the inserted pilot signals (330). A determination is made as to whether the ratio of estimated noise power to estimated channel response is greater than a predetermined value (i.e., the noise overwhelms the received A/V signal) (340). If it is determined that the ratio of estimated noise power to estimated channel response is greater than the predetermined value, then an OFDM carrier in the A/V signal is declared as a null (350). The nulls are processed as erasures during decoding (360). If the ration of estimated noise power to estimated channel response is not greater than the predetermined value, then the OFDM carrier in the A/V is treated decoded as if the data is normal (345).

While the examples above are shown for use in a DVB-T system, they may also be used in other broadcasting networks. Examples of broadcasting networks includes second generation Digital Video Broadcasting—Terrestrial (DVB-T2) Digital Video Broadcasting—Terrestrial/handheld (DVB-T/H), Integrated Services Digital Broadcasting (ISDB)-T, Digital Audio Broadcasting—Terrestrial (DAB-T), Terrestrial-Digital Multimedia Broadcasting (T-DMB), Digital Multimedia Broadcasting-terrestrial/handheld (DMB-TH), and Media-FLO.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. An orthogonal frequency-division multiplexing (OFDM) receiver configured to communicate in a single frequency network (SFN), the OFDM receiver comprising:
a synchronization and channel estimation (SCE) block configured to estimate a noise level of a received input bitstream based on an included pilot signal; and
a null detection block configured to detect a null in the input bitstream based on the estimated noise level.

2. The OFDM receiver of claim 1, further comprising:
a soft demapper configured to generate a soft binary signal, wherein if a null is detected, the soft demapper sets the value of the soft binary signal to a predetermined value.

3. The OFDM receiver of claim 2, further comprising:
a soft channel decoder configured to detect a null in the soft binary signal based on the predetermined value, and to process the null as an erasure.

4. The OFDM receiver of claim 1, further comprising:
a soft channel decoder configured to receive a soft binary signal and to receive a second signal that identifies a portion of the soft binary signal as a null, wherein the soft channel decoder processes the null as an erasure.

5. The OFDM receiver 2, wherein the predetermined value is a 0.5 for a signal range between 0 and 1.

6. The OFDM receiver 2, wherein the predetermined value is a 0 for a signal range between −1 and 1.

7. The OFDM receiver of claim 1, further comprising:
a one-tap equalizer configured to equalize channel effects.

8. The OFDM receiver of claim 1, wherein the pilot signal is a transmission parameter signaling (TPS) signal.

9. The OFDM receiver of claim 1, configured to communicate in a Digital Video Broadcasting-Terrestrial (DVB-T) system.

10. A method for null detection in a single frequency network (SFN), the method comprising:
determining a noise level of a received input bitstream based on an included pilot signal;
detecting a null in the input bitstream based on the noise level; and
setting a value of a soft binary signal to a predetermined value to identify the null.

11. The method of claim 10, wherein the pilot signal is a signal carrying known data with a known modulation.

12. The method of claim 11, wherein determining the noise level is based on the pilot signal.

13. The method of claim 12, wherein the predetermined soft binary value is 0.5 if data range between 0 and 1.

14. The method of claim 10, further comprising:
processing the soft binary signal as an erasure if the soft binary signal is equal to the predetermined value.

15. A machine readable storage medium having a stored set of instructions executable by a machine, the instructions comprising:
instructions to determine a noise level of a received input bitstream based on a pilot signal;
instructions to detect a null in the input bitstream based on the noise level; and
instructions to set a value of a soft binary signal to a predetermined value to identify the null.

16. The machine readable storage medium of claim 15 wherein the instructions to determine the noise level is based on the pilot signal.

17. A computer-readable medium containing a first set of instructions adapted to create a processor, wherein the processor is configured to implement a second set of instructions, the second set of instructions comprising:
instructions to determine a noise level of a received input bitstream based on a pilot signal;
instructions to detect a null in the input bitstream based on the noise level; and
instructions to set a value of a soft binary signal to a predetermined value to identify the null.
